(19) United States
(12) Patent Application Publication
(10) Pub. No.: US 2008/0111319 A1
(43) Pub. Date: May 15, 2008

(54) Sealing Ring For Push-Fit Socket Connections

(75) Inventors: Eckard Nowack, Brande-Hörnerkirchen (DE); Michael Bode, Hamburg (DE)

Correspondence Address: FRIEDRICH KUEFFNER, 317 MADISON AVENUE, SUITE 910, NEW YORK, NY, 10017, US

(73) Assignee: BODE GMBH, Henstedt-Ulzburg (DE)

(21) Appl. No.: 11/632,590

(22) PCT Filed: Jan. 17, 2005
(86) PCT No.: PCT/DE05/00060

§ 371 Date: Sep. 17, 2007

(30) Foreign Application Priority Data
Jul. 20, 2004 (DE) 10 2004 038 333.2

(51) Int. Cl. F16L 21/03

(52) U.S. Cl. 277/616

(57) ABSTRACT

The invention relates to a sealing ring (1) for push-fit socket connections. The sealing ring (1) is characterized by consisting of a high-quality elastomeric plastic material or an elastomer as an element of the scaling ring and comprises, on the seal base, an end piece (2) from a harder plastic material, such as PP, as the care which is at least partially surrounded by the sealing material (3), thereby forming a base element. The end piece (2) as the core of the inserted sealing (1) is associated, at the seal base in the direction of insertion of the pipe, with the bead (5) and its end section is configured without sealing material (3) at the seal base.

The invention concerns a sealing ring for plug-in bell-and-spigot joints for tubular bodies such as house drain pipes and sewer pipes, wherein an elastic sealing ring made of plastic is arranged in an inwardly open, peripheral groove, which serves as the standard bead of the pipe; wherein a seal is formed between the inside of one pipe and the outer circumferential surface of a another pipe inserted through the sealing ring; wherein the sealing ring is formed by a base element inserted into the groove, which base element has sealing lips arranged at an angle to the direction of insertion, which lips can be bent in their angled direction by the inserted pipe; and wherein at least one compression lip is provided in the insertion direction of the pipe.

Designs of this type are known in a wide variety of embodiments. However, it has been found that it is relatively expensive to fill a standard bead with a sealing ring effectively and at the same time to achieve a good sealing effect. In this regard, there is often the disadvantage that the materials that are used for sealing rings of this type result in high costs and that the root strength in the bead is poor.

It is also known that reinforcing rings can be integrated into the seal. This requires extra effort to produce the seal, and the seal must also be made with the proper dimensions so that it can be positioned precisely in the bead.

The objective of the invention is to create an economical design of a sealing ring of this general type with the use of a minimum amount of high-quality sealing material, which sealing ring can be produced simply and which allows the bead to be filled to a high degree.

In accordance with the invention, the solution to the stated problem is characterized in that the sealing ring consists of a component in the form of a sealing element of high-quality elastomeric plastic such as TPE, TPU, or an elastomer, which has an end piece, made of harder plastic such as PP, which is at least partially enclosed by the sealing material, where the free terminal section of the end piece of the inserted sealing ring, i.e., the section with no sealing material located at the front end of the seal with respect to the insertion direction, is assigned to the bead.

This makes it possible to minimize the proportion of expensive sealing material and still obtain a functional sealing ring.

In addition, it is proposed as a refinement of the invention that the different materials of the sealing region and the core be bonded to each other to form a two-component joint.

To facilitate assembly, the invention provides that a lubricant is incorporated into the sealing material to form a lubricating film on the surface of the seal.

In accordance with an advantageous refinement of the invention, the cross section of the end piece forms an angle, where one side of the angle forms the outer terminal section at the front end of the seal, whereas the other side of the angle is enclosed by the sealing material.

It is further proposed that the end piece have a recess by which it can be held during a production process.

The schematic drawings show a specific embodiment of the invention.

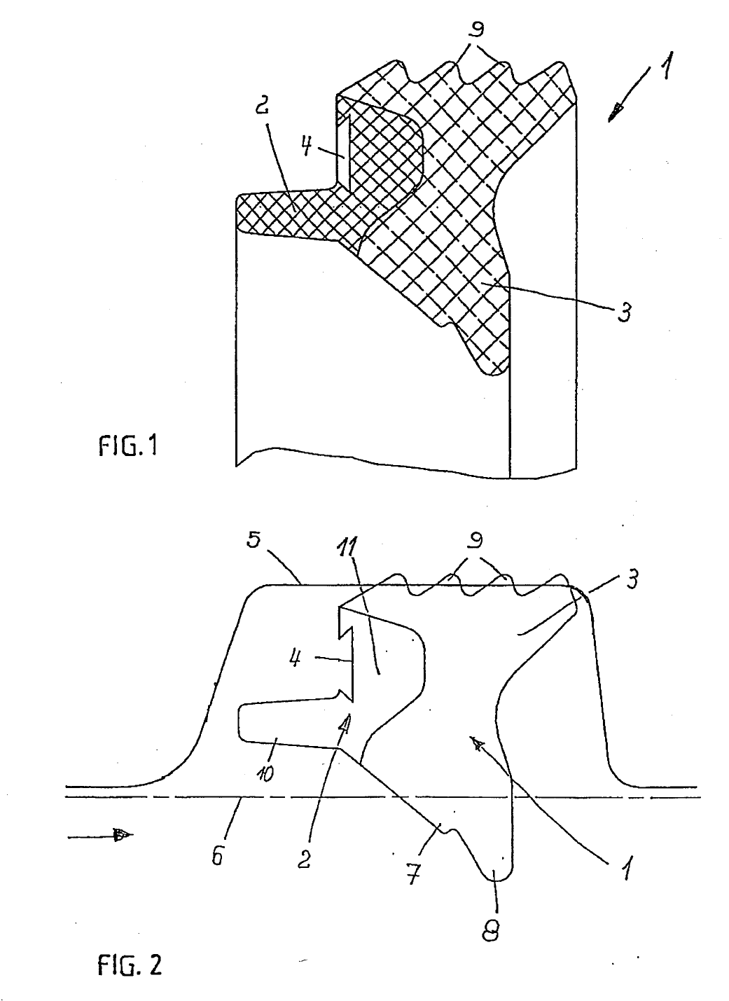

FIG. 1 shows a section through the sealing ring.

FIG. 2 shows a sealing ring inserted into a bead.

The illustrated sealing ring 1 is formed by plastic components, where an end piece 2 at the front end of the seal is partially enclosed by sealing material 3 to form the sealing element. The two components of the sealing element can be produced simultaneously by injection-molding in the known manner.

The sealing material 3 of the sealing element is made of a high-quality elastomeric plastic, for example, TPE, TPU, or an elastomer such as SBR, whereas the end piece 2 is made of a harder, less expensive plastic such as PP. The end piece 2 should constitute as large a portion of the sealing ring 1 as possible.

The end piece 2 at the front end is located on the side of the seal that faces in the direction in which the pipe to be inserted will be pushed, as indicated by the line 6, and protrudes from the sealing material 3 of the sealing element.

The assembled view according to FIG. 2 shows how the sealing ring 1 is accommodated in the bead 5 of a pipe. The sealing ring consists of the end piece 2 at the front end and the sealing material 3, serving as the actual sealing element, which has inwardly directed sealing lips 7 and 8, which are set at an angle to the direction in which the pipe to be inserted will be pushed. Sealing lip 7 is in the forward position with respect to the insertion direction and acts as a compression lip, while sealing lip 8 follows it in the insertion direction.

On the outer diameter of the seal, the sealing ring 1 is provided with outer contouring 9 to improve the sealing action.

The end piece 2 is designed as an angled piece, wherein one side 10 of the angle forms an outer terminal section, while the other side 11 of the angle is enclosed by the sealing material. The side 11 of the angle that faces away from the sealing material 3, furthermore, has a recess 4 by which the end piece 2 can be held during a production process.

1. A sealing ring for plug-in bell-and-spigot joints for tubular bodies such as house drain pipes and sewer pipes, where an elastic sealing ring made of plastic is arranged in an inwardly open, peripheral groove, which serves as the standard bead of the pipe; where a seal is formed between the inside of one pipe and the outer circumferential surface of another pipe, which is inserted through the sealing ring; where the sealing ring is formed by a base element inserted into the groove, which base element has sealing lips, which are set at an angle to the direction of insertion and can be bent in the angled direction by the inserted pipe; and where at least one compression lip is formed in the insertion direction of the pipe, wherein the sealing ring (1) consists of a component in the form of a sealing element of high-quality elastomeric plastic such as TPE, TPU, or an elastomer, which has an end piece (2), made of harder plastic such as PP, which is at least partially enclosed by the sealing material (3), where the free terminal section of the end piece of the inserted sealing ring, i.e., the section with no sealing material located at the front end of the seal with respect to the insertion direction, is assigned to the bead.

2. A sealing ring according to claim 1, wherein the different materials of the sealing region (3) and the end piece (2) are bonded to each other as a two-component joint.

3. A sealing ring according to claim 1, wherein a lubricant is incorporated into the sealing material (3) to form a lubricating film on the surface of the seal.

4. A sealing ring in accordance with claim 1, wherein the end piece (2) has an angular cross section, where one side (10) of the angle forms the outer terminal section at the front end of the seal, whereas the other side (11) of the angle is enclosed by the sealing material (3).

5. A sealing ring in accordance with claim 1, wherein the end piece (2) has a recess (4) by which it can be held during a production process.
